(19) United States
(12) Patent Application Publication
(10) Pub. No.: US 2026/0144368 A1
(43) Pub. Date: May 28, 2026

(54) TABLE AND CHAIR FOOT COVER AND MANUFACTURING METHOD THEREOF

(71) Applicant: Shenzhen Henghuida Industry Co., Ltd., SHENZHEN (CN)

(72) Inventor: HENG LU, Shenzhen (CN)

(21) Appl. No.: 19/042,690

(22) Filed: Jan. 31, 2025

(30) Foreign Application Priority Data
Nov. 28, 2024 (CN) 202422919142.X

(51) Int. Cl. A47B 91/12; B32B 1/00; B32B 5/02; B32B 7/12; B32B 27/12; B32B 27/30; B32B 27/40

(52) U.S. Cl. CPC A47B 91/12; B32B 1/00; B32B 5/022; B32B 7/12; B32B 27/12; B32B 27/306; B32B 27/40; B32B 2307/202; B32B 2479/00

(57) ABSTRACT

A table and chair foot cover is provided, including a foot cover main body and a cover bottom. The cover bottom is disposed at a bottom of the foot cover main body. The foot cover main body is formed with a cover hole and a cavity. The cover bottom includes a smooth layered structure and an anti-static layered structure. The smooth layered structure includes a sticky layer and a fitting layer. The sticky layer is configured to bond the fitting layer with the bottom of the foot cover main body. The anti-static layered structure includes a plastic layer and a conductive layer. The plastic layer is configured to bond the conductive layer with the fitting layer. The above table and chair foot cover achieves effects of abrasion resistance and hair non-sticking. A method for manufacturing the table and chair foot cover is further provided.

### CROSS REFERENCE TO RELATED APPLICATIONS

The present application claims the priority of Chinese patent application No. 202422919142.X, filed on Nov. 28, 2024, and contents of which are incorporated herein by reference.

### TECHNICAL FIELD

The present disclosure relates to the technical field of furniture accessories, more particularly to a table and chair foot cover.

### BACKGROUND

Table foot and chair foot (called table and chair foot collectively) are generally made of wood or metal rods, which, if directly contacting a flooring during movement, are prone to abrade the flooring and will generate uncomfortable noises. Therefore, table and chair foot covers are designed for sleeving on table and chair feet, to prevent flooring abrasion and eliminate the noises generated by the pulling of table and chair.

At present, common table and chair foot covers available in the market mostly have bottoms made of non-woven fabric, cloth and the like material, which are easy to sticky to hair, dust and other things after contacting and rubbing on the flooring, not only affecting the aesthetical effect, but also increasing the difficulty of cleaning. Furthermore, the table and chair foot covers with foreign substances attached on will affect the sliding performance, make the non-woven fabric or cloth structure easily worn out, and generate abnormal sounds during the pulling process of chair.

### SUMMARY

It is an object of the present disclosure to provide a table and chair foot cover, which is abrasion resistant and non-sticky to hair.

The table and chair foot cover provided by the present disclosure employs the following technical scheme.

A table and chair foot cover includes a foot cover main body and a cover bottom. The cover bottom is disposed at a bottom of the foot cover main body. The foot cover main body is formed with a cover hole and a cavity. The cover bottom includes a smooth layered structure and an anti-static layered structure. The smooth layered structure includes a sticky layer and a fitting layer. The sticky layer is configured to bond the fitting layer with the bottom of the foot cover main body. The anti-static layered structure includes a plastic layer and a conductive layer. The plastic layer is configured to bond the conductive layer with the fitting layer.

In a preferred embodiment, the sticky layer is of a high-density non-woven fabric material; and the fitting layer is of an ethylene-vinyl acetate copolymer foam material.

In a preferred embodiment, the plastic layer is of a polyurethane material.

In a preferred embodiment, the conductive layer is woven from conductive fibers and anti-static fibers.

In a preferred embodiment, the foot cover main body is of an elastic material; and the cover hole has a diameter less than an inner diameter of the cavity.

In a preferred embodiment, a bottom of the cavity is provided with a plurality of anti-slip bumps in a rectangular array; and an anti-slip recess is formed between the anti-slip bumps.

In a preferred embodiment, the anti-slip bump is in a square shape. The square anti-slip bump increases gradually in size from top to bottom; and the anti-slip bump is made of an elastic material.

In a preferred embodiment, an outer sidewall of the foot cover main body is formed with an annular limit groove; and an opening edge of the cover bottom is fixedly inserted into the annular limit groove.

In a preferred embodiment, an outside bottom of a bottom end of the foot cover main body is a convex surface protruding downwardly. A cross section of the convex surface is a circular arc surface, and a cross section of an inside bottom of the cover bottom is a circular arc surface.

The foot cover provided by the present disclosure has the following beneficial effects. By means of the conductive layer of the anti-static layered structure, the cover bottom is electrostatic resistant and thus has a hair non-sticky effect. By means of the plastic layer of the anti-static layered structure, an abrasion resistant effect is achieved.

It is another object of the present disclosure to provide a method for manufacturing a table and chair foot cover, with which the manufactured table and chair foot cover is non-sticky to hair and is abrasion resistant.

The table and chair foot cover provided by the present disclosure employs the following technical scheme.

A method for manufacturing a table and chair foot cover includes the following steps:

producing a bottom sheet: weaving conductive fibers into anti-static fibers employing a blending technology to form an anti-static fabric, and attaching a soft plastic material tightly onto the anti-static fabric employing a rolling and bonding process to produce a bottom sheet;

attaching a fitting layer material onto the bottom sheet by means of glue, attaching a sticky layer material onto the fitting layer material by means of glue, rolling and bonding, cutting into pieces using a vertical cutting machine, and placing the cut pieces into an oven to bake and soften, placing the soften cut pieces into a mold, hot pressing and shaping, and trimming by means of a punch to obtain a cover bottom for the table and chair foot cover; and

injection molding: placing the cover bottom into a mold cavity of an injection mold, closing the mold and injecting a thermoplastic foot cover main body material to obtain the table and chair foot cover.

The method for manufacturing a table and chair foot cover provided by the present disclosure has the following beneficial effects. Electric conduction is carried out by means of the conductive fibers of the conductive layer of the anti-static layered structure, whereby the cover bottom is electrostatic resistant and thus has a hair non-sticky effect. By means of the plastic layer of the anti-static layered structure, an abrasion resistant effect is achieved.

### BRIEF DESCRIPTION OF THE DRAWINGS

FIG. 1 is a structure diagram of a table and chair foot cover of the present disclosure.

FIG. 2 is a structure diagram of a cover bottom in a table and chair foot cover of the present disclosure.

FIG. 3 is an exploded view of a table and chair foot cover of the present disclosure.

FIG. 4 is a top view of a table and chair foot cover of the present disclosure.

### DETAILED DESCRIPTION OF THE EMBODIMENTS

The present disclosure is illustrated and described below in further detail in conjunction with specific embodiments and accompanying drawings.

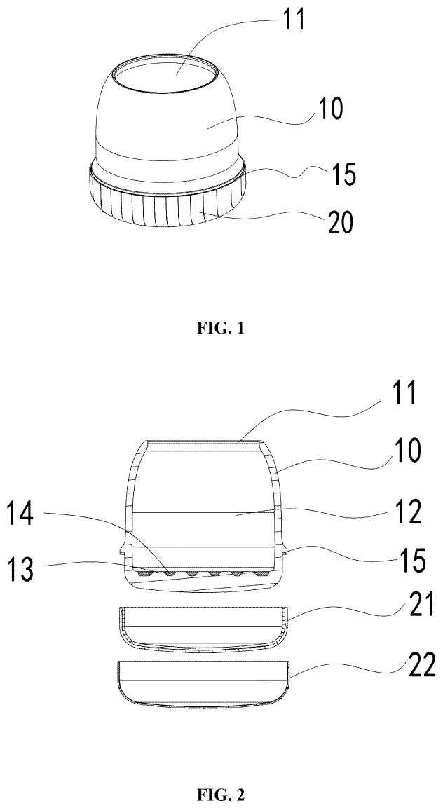

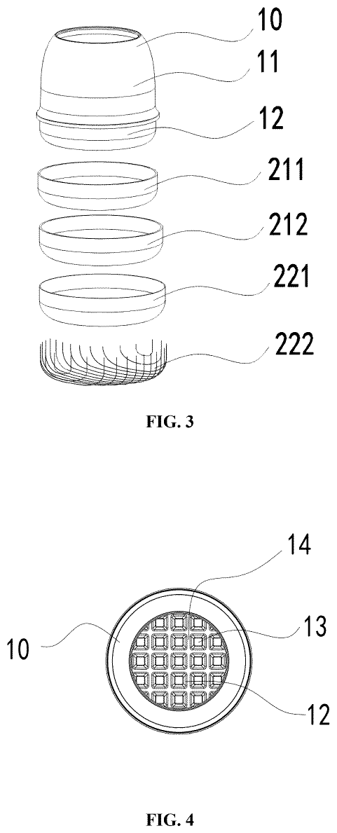

Referring to FIG. 1 to FIG. 4, a foot cover includes a foot cover main body 10 and a cover bottom 20. The cover bottom 20 is disposed at a bottom of the foot cover main body 10. The cover bottom 20 includes a smooth layered structure 21 and an anti-static layered structure 22. The smooth layered structure 21 includes a sticky layer 211 and a fitting layer 212. The sticky layer 211 is configured to bond the fitting layer 212 with the bottom of the foot cover main body 10. One side of the sticky layer 211 is bonded with the foot cover main body 10 while another side thereof is bonded with the fitting layer 212. The anti-static layered structure 22 includes a plastic layer 221 and a conductive layer 222. The conductive layer 222 is formed by blended weaving of conductive fibers and an abrasion-resistant fiber material such as Nylon fibers. The plastic layer 221 is configured to bond the conductive layer 222 with the fitting layer 212. One side of the plastic layer 221 is bonded with the fitting layer 212 while another side thereof is bonded with the conductive layer 222.

The sticky layer 211 is of a high-density non-woven fabric material. The sticky layer 211 employs a high-density non-woven fabric, ensuring a tight fit between a bottom end of the foot cover main body 10 and the fitting layer 212, preventing separation and disengagement after long-term use and prolonging the service life. The fitting layer 212 employs an EVA (ethylene-vinyl acetate copolymer) foam material, which has characteristics of high transparency, high durability, high adhesive strength, low melting point, easy processing and the like, can provide a neat and smooth surface and meanwhile can tightly fit with the sticky layer 211.

The plastic layer 221 is of a PU (polyurethane) material. The PU material has high polarity and activity and has good adhesivity to various metal and non-metal materials. The abrasion-resistant fiber material in the conductive layer 222 is a polyamide fiber material. The polyamide fiber material has characteristics of hair non-sticking and electrostatic resistance and has effects of abrasion resistance, water proofing, slip facilitation, muting and the like, which is suitable for various types of flooring such as tile flooring, wooden flooring, carpet flooring, etc. The abrasion-resistant fiber material is woven with conductive fibers such as metal fibers, carbon fibers and graphene fibers to form the conductive layer 222. The plastic layer 221 is laminated onto the conductive layer 222 by a special process, to enhance the stability of the conductive layer 222 and the tightness with the plastic layer 221. In the present embodiment, the plastic layer 221 employs a PU material, while the conductive layer 222 employs a blended fabric of an abrasion-resistant polyamide fiber material and conductive fibers, whereby the surface is smoother and finer and can effectively improve conductivity while keeping good flexibility and durability. Combining the advantages of the two fibers, a composite fiber is formed that has high conductivity and good mechanical properties, thereby achieving the effects of electrostatic resistance and abrasion resistance.

The foot cover main body 10 is of an elastic material. The foot cover main body 10 is formed with a cover hole 11 and a cavity 12. The cover hole 11 has a diameter less than an inner diameter of the cavity 12.

The foot cover main body 10 employs an elastic material, such as thermoplastic elastomer (TPE), rubber, silicone rubber or other flexible materials having good elasticity, whereby the foot cover can tightly fit with various shapes and sizes of chair legs or table legs, ensuring stable installation and good adhesion. The diameter of the cover hole 11 is designed to be less than the inner diameter of the cavity 12, so that a tight fit can be achieved by means of the extension and contraction of the elastic material when the foot cover is sleeved on a chair leg or table leg.

In other embodiments, the TPE material used by the foot cover main body 10 can be further optimized, for example, arranging anti-slip patterns or regulating a material hardness to improve comfort of usage.

A bottom of the cavity 12 is provided with a plurality of anti-slip bumps 13 in a rectangular array. An anti-slip recess 14 is formed between the anti-slip bumps 13. The anti-slip bump 13 is in a square shape. The square anti-slip bump 13 increases gradually in size from top to bottom. When a table or chair is stressed, the table or chair foot presses down the anti-slip bumps 13, then the contact area between the table or chair foot and the anti-slip bumps 13 is increased, whereby increasing the friction therebetween. Meanwhile, when the table or chair is stressed, the table or chair foot causes an increase in the pressure between the cover bottom 20 and the ground, whereby increasing the friction between the cover bottom 20 and the ground and thus further improving the anti-slip effect of the table and chair foot cover.

An outer sidewall of the foot cover main body 10 is formed with an annular limit groove 15, and an opening edge of the cover bottom 20 is fixedly inserted into the annular limit groove 15, whereby enhancing the fitting effect between the cover bottom 20 and the foot cover main body 10.

An outside bottom of a bottom end of the foot cover main body 10 is a convex surface protruding downwardly. A cross section of the convex surface is a circular arc surface, and a bottom of the cover bottom 20 is a circular arc surface, whereby reducing the contact area between the cover bottom 20 and the ground and easing the movement of the table and chair foot cover on the ground. When a table or chair is stressed, the table or chair foot causes the cover bottom 20 of the table and chair foot cover to become flattened, increasing the contact area and friction between the table and chair foot cover and the ground.

According to the table and chair foot cover provided in the present embodiment, the foot cover main body 10 is made of an elastic material, which can tightly fit with a table or chair foot and thus improves the reliability of installation. By means of the anti-static layered structure 22, the foot cover has conductivity and durability improved and achieves effects of hair non-sticking and durability. By means of the smooth layered structure 21, a tighter fit is achieved between the foot cover main body and the cover bottom.

A method for manufacturing a table and chair foot cover includes the following steps.

Producing a bottom sheet: conductive fibers are woven into anti-static fibers employing a blending technology to form a conductive layer fabric, and a soft plastic material is attached onto the conductive layer fabric by means of the rolling and bonding of a roller press to produce a bottom sheet of an anti-static layered structure. The conductive fiber may employ metal fiber, carbon fiber and graphene fiber. The anti-static fiber may employ nylon fiber. The soft plastic material is a PU material.

A fitting layer material is attached onto the bottom sheet by means of glue. A sticky layer material is attached onto the fitting layer material by means of glue. Then, they are rolled and bonded by a roller press and are cut into pieces using a vertical cutting machine. The cut pieces are placed into an oven to bake and soften, then the soften cut pieces are placed into a mold for hot pressing and shaping. Next, they are trimmed by means of a punch to obtain a cover bottom of the table and chair foot cover. The sticky layer material employs a non-woven fabric. The fitting layer material employs EVA.

Injection molding: the cover bottom is placed into a mold cavity of an injection mold; then, the mold is closed and a thermoplastic material is injected to form a foot cover main body, which bonds with the cover bottom to obtain a table and chair foot cover. The thermoplastic material employs TPE, rubber, silicone rubber or other flexible materials having good elasticity.

### Embodiment 1

Graphene fibers were blended with nylon fibers to form a conductive layer fabric, of which a measured surface resistivity was 10⁶Ω/sq. A PU material was rolled and bonded onto the conductive layer fabric by a roller press to obtain a bottom sheet of an anti-static layered structure. A fitting layer material of EVA was bonded onto the bottom sheet. A sticky layer material of non-woven fabric was bonded onto the fitting layer material. Then, they were rolled and bonded, cut into pieces, and placed into an oven to bake, where the baking temperature was 195 degrees centigrade and the baking time was 5 minutes. Next, they were hot pressed and shaped and trimmed to obtain cover bottoms of table and chair foot covers. Then, the cover bottoms were placed into mold cavities and rubber was injected, to produce ten table and chair foot covers with a diameter of 1 inch.

### Embodiment 2

Aluminum fibers were blended with nylon fibers to form a conductive layer fabric, of which a measured surface resistivity was 10⁷Ω/sq. A PU material was rolled and bonded onto the conductive layer fabric to obtain a bottom sheet of an anti-static layered structure. A fitting layer material of EVA was bonded onto the bottom sheet. A sticky layer material of non-woven fabric was bonded onto the fitting layer material. Then, they were rolled and bonded, cut into pieces, and placed into an oven to bake, where the baking temperature was 195 degrees centigrade and the baking time was 5 minutes. Next, they were hot pressed and shaped and trimmed to obtain cover bottoms of table and chair foot covers. Then, the cover bottoms were placed into mold cavities and rubber was injected, to produce ten table and chair foot covers with a diameter of 1 inch.

Five table and chair foot covers produced in Embodiment 1 and five table and chair foot covers produced in Embodiment 2 were taken for rubbing by an abrasion tester JQ-896 produced by Dongguan Jian Qiao Test Equipment Co., LTD under the condition of bearing 50 Kg and turning on and off 5000 times. None of these table and chair foot covers produced in Embodiment 1 and Embodiment 2 were worn through. Five table and chair foot covers produced in Embodiment 1 and five table and chair foot covers produced in Embodiment 2 were taken for a temperature change from 70 degrees centigrade to −20 degrees centigrade by a high-low temperature tester HT-KIW40-150L produced by Dongguan Huitai Instrument Equipment Co., LTD. None of these table and chair foot covers produced in Embodiment 1 and Embodiment 2 were disengaged or deformed.

It can be seen from the above that the table and chair foot cover manufactured by the method for manufacturing a table and chair foot cover provided by the present disclosure achieves effects of abrasion resistance, electrostatic resistance and hair non-sticking.

Finally, it should be noted that the above embodiments are merely to describe the technical scheme of the present disclosure, rather than to limit it. Although the present disclosure has been illustrated in detail with reference to preferred embodiments, the ordinary skill in the art should understand that modifications or equivalent substitution can be made to the technical scheme of the present disclosure without departing from the essence and scope of the technical scheme of the present disclosure.

What is claimed is:

1. A table and chair foot cover, comprising a foot cover main body and a cover bottom, the cover bottom being disposed at a bottom of the foot cover main body, and the foot cover main body being formed with a cover hole and a cavity, wherein the cover bottom comprises a smooth layered structure and an anti-static layered structure, the smooth layered structure comprising a sticky layer and a fitting layer, wherein the sticky layer is configured to bond the fitting layer with the bottom of the foot cover main body, and the anti-static layered structure comprising a plastic layer and a conductive layer, wherein the plastic layer is configured to bond the conductive layer with the fitting layer.

2. The table and chair foot cover according to claim 1, wherein the sticky layer is of a high-density non-woven fabric material, and wherein the fitting layer is of an ethylene-vinyl acetate copolymer foam material.

3. The table and chair foot cover according to claim 1, wherein the plastic layer is of a polyurethane material.

4. The table and chair foot cover according to claim 1, wherein the conductive layer is woven from conductive fibers and anti-static fibers.

5. The table and chair foot cover according to claim 1, wherein the foot cover main body is of an elastic material, and wherein the cover hole has a diameter less than an inner diameter of the cavity.

6. The table and chair foot cover according to claim 5, wherein a bottom of the cavity is provided with a plurality of anti-slip bumps in a rectangular array, and wherein an anti-slip recess is formed between the anti-slip bumps.

7. The table and chair foot cover according to claim 6, wherein the anti-slip bump is in a square shape, the square anti-slip bump increasing gradually in size from top to bottom; and wherein the anti-slip bump is made of an elastic material.

8. The table and chair foot cover according to claim 1, wherein an outer sidewall of the foot cover main body is formed with an annular limit groove, and wherein an opening edge of the cover bottom is fixedly inserted into the annular limit groove.

9. The table and chair foot cover according to claim 1, wherein an outside bottom of a bottom end of the foot cover main body is a convex surface protruding downwardly, wherein a cross section of the convex surface is a circular arc surface, and wherein a cross section of an inside bottom of the cover bottom is a circular arc surface.

10. A method for manufacturing a table and chair foot cover, comprising the following steps:
producing a bottom sheet: weaving conductive fibers into anti-static fibers employing a blending technology to form an anti-static fabric, and attaching a soft plastic material tightly onto the anti-static fabric employing a rolling and bonding process to produce a bottom sheet;
attaching a fitting layer material onto the bottom sheet by means of glue, attaching a sticky layer material onto the fitting layer material by means of glue, rolling and bonding, cutting into pieces using a vertical cutting machine, and placing the cut pieces into an oven to bake and soften, placing the soften cut pieces into a mold, hot pressing and shaping, and trimming by means of a punch to obtain a cover bottom for the table and chair foot cover; and
injection molding: placing the cover bottom into a mold cavity of an injection mold, closing the mold and injecting a thermoplastic foot cover main body material to obtain the table and chair foot cover.
